(19) United States
(12) Patent Application Publication
(10) Pub. No.: US 2011/0148350 A1
(43) Pub. Date: Jun. 23, 2011

(54) System for Charging a Battery in a Motor Vehicle

(75) Inventors: Fritz Wegener, Gilching (DE); Thorsten Schmeier, Utting (DE)

(73) Assignee: HS Genion GmbH, Gilching (DE)

(21) Appl. No.: 12/966,708

(22) Filed: Dec. 13, 2010

(30) Foreign Application Priority Data
Dec. 22, 2009 (DE) 10 2009 059 976.2

(51) Int. Cl. H02J 7/00

(52) U.S. Cl. 320/108; 320/109

(57) ABSTRACT

A system is proposed for charging a battery in a motor vehicle (10), comprising a stationary charging station (14) and a coupling unit (12) which is fixed to the vehicle. The coupling unit (12) which is fixed to the vehicle has a coupling element (22, 42, 56, 68, 74, 94) which is arranged at the vehicle front, at the vehicle rear or on one of the vehicle sides, and which is electrically coupled, at least in a charging position, to a charging element (30) of the charging station (14), with the coupling element (22, 42, 56, 68, 74, 94) projecting with respect to a fixed vehicle outer skin section and engaging in the charging element (30, 92) of the charging station, or engaging in the coupling element when the charging element of the charging station is in a charging position, or the coupling element being integrated flush, without any contours or concealed in the vehicle front, at the vehicle rear or on one of the vehicle sides, and being inductively coupled to the charging element of the charging station in a charging position.

The invention relates to a system for charging a motor vehicle, according to the preamble of patent claim 1.

Recently, electrical vehicles are in ever more widespread use. In order to keep the process of charging the battery of the electrical vehicle as simple as possible, it is necessary to provide a widespread network of charging stations. This is also justified by the limited range of previous electrical vehicles. Furthermore, one aim is to make the charging process as convenient as possible for the user.

Various charging systems for electrical vehicles are known from practical use. These may be in the form of conductive or inductive systems. In the case of conductive systems, when the motor vehicle battery is being charged, a stationary charging station is connected via electrical connectors to a coupling unit which is fixed to the vehicle. By way of example, the charging station has an electrical plug connector, which is inserted into a corresponding socket in the relevant motor vehicle. In the case of inductive systems, the charging station represents the primary side, which produces a magnetic field which acts on a coil in the coupling unit, which is fixed to the vehicle and represents the secondary side, where an electric current is induced, which can be stored in the motor vehicle battery.

One known, inductively operating charging system is designed such that the charging station or the primary side is a charging plate, which is arranged on the ground or is integrated in the ground. The secondary side, which is formed by the coupling unit which is fixed to the vehicle, is therefore a minimum distance away, which is predetermined by the ground under the relevant vehicle. This distance may be sufficiently great that the efficiency of the charging system becomes inadequate.

The invention is based on the object of providing a system for charging a battery in a motor vehicle, which allows simple coupling between the stationary charging station and the coupling unit which is fixed to the vehicle, and therefore allows a charging process which is convenient to use.

According to the invention, this object is achieved by the system for charging a battery in a motor vehicle having the features of patent claim 1.

Therefore, according to the invention, a system is proposed for charging a battery in a motor vehicle, comprising a stationary charging station and a coupling unit which is fixed to the vehicle. The coupling unit which is fixed to the vehicle in turn has a coupling element which is arranged at the vehicle front, at the vehicle rear or on one of the vehicle sides, and which is electrically coupled, at least in a charging position, to a charging element of the charging station, with the coupling element projecting with respect to a fixed vehicle outer skin section and engaging in the charging element of the charging station, or engaging in the coupling element when the charging element of the charging station is in a charging position, or the coupling element being integrated flush, without any contours or concealed in the vehicle front, at the vehicle rear or on one of the vehicle sides, and being inductively coupled to the charging element of the charging station in a charging position.

In the case of the charging system according to the invention, it is also possible for the relevant user or driver of the relevant motor vehicle to move the vehicle to a specific position in order to couple the coupling unit which is fixed to the vehicle to the stationary charging station, in which position the stationary charging station and the coupling unit which is fixed to the vehicle can be coupled to one another.

The terms vehicle front and vehicle rear should in each case be understood in their broadest sense, and also include vehicle side areas at the front and rear, which are connected to the end surfaces of the relevant vehicle. For example, in the case of a bumper which is arranged at the front or at the rear, the end areas both end on the sides of the vehicle. Such end areas can also be associated with the vehicle front or the vehicle rear, for the purposes of the invention.

By way of example, the coupling element of the coupling unit which is fixed to the vehicle is a structural element, which is arranged rigidly with respect to the vehicle structure, of the relevant motor vehicle, which projects with respect to the adjacent vehicle structure and engages in a corresponding receptacle in the charging station.

In one specific embodiment of the charging system according to the invention, the coupling element represents at least a part of a bumper or a bumper bar of the motor vehicle which, when in the charging position, engages in a charging rail, which forms the charging element, of the charging station. It is also feasible for the coupling element to be formed by a rigid or extendable trailer coupling on the relevant vehicle.

In a further specific embodiment, a coupling element in the form of a plate can be rigidly integrated at a desired point on the periphery of the vehicle, that is to say at the vehicle front, at the vehicle rear or on one of the vehicle sides, in which case, in order to reach the charging position, the vehicle is then moved in its entirety to an optimum position with respect to the charging station, as a result of which the coupling element and the charging element of the charging station can be electrically coupled to one another. To do this, it is advantageous for the charging system to have a distance sensor system. In particular, the distance sensor system which is provided in any case on the relevant vehicle and is used as a parking aid can also be used as the distance sensor system.

In one alternative embodiment of the charging system according to the invention, the coupling element is a charging arm which can preferably be extended with respect to the vehicle structure by means of a drive. When the vehicle is being driven, the charging arm is accommodated in the vehicle structure. The charging arm is extended in order to charge the battery in the vehicle.

The charging arm may be moveable linearly and, in this case, may be driven by means of a drive wheel, which engages in a toothed-rod section, or else may be mounted such that it can pivot.

One embodiment, which occupies only a small physical space, is provided when the charging arm is driven by means of a cable run, which can be operated manually or else by means of an actuating drive, which is arranged at a suitable point on the relevant motor vehicle.

In one specific embodiment, the charging arm is mounted in a housing which is fixed to the vehicle. This housing is preferably fixed in a corresponding recess at the front or at the rear of the relevant motor vehicle.

In order to improve road safety and to improve the visual appearance of the relevant motor vehicle as well, one advantageous embodiment of the housing has a cover element which can pivot or else can be moved linearly.

The cover element may be electrically operable by means of an appropriate drive, or else may be prestressed in the closed position by means of a spring device, such that the extending charging arm forces it to an open position.

By way of example, the cover element, which can pivot, is a license plate of the motor vehicle. This means that the license plate is pivoted in order to charge the battery in the motor vehicle, as a result of which the charging arm can be coupled to the charging station.

In order to allow the relevant motor vehicle to be moved accurately to a charging position, the coupling unit which is fixed to the vehicle preferably has at least one distance sensor for measurement of the distance between the coupling element and the charging element.

In order to allow the charging station to be automatically coupled to the coupling unit which is fixed to the vehicle, the charging system according to the invention may have an automatic positioning device which, when the vehicle is parked, guides the coupling arm to the charging element of the charging station, or guides the charging element of the charging station to the coupling element of the coupling unit which is fixed to the vehicle.

Furthermore, the charging system according to the invention may have an automatic positioning device which guides the vehicle to a charging position and interacts with a steering unit and/or a drive unit in the vehicle.

In order to indicate the optimum position of the vehicle and/or the charging position to the driver of the relevant vehicle, a visual and/or audible signaling unit may be provided, which indicates that the charging position has been reached. For example, the vehicle parking assistance system can have an additional light added to it, in a further color, or may have an additional signal tone added to it.

In order to simplify the coupling between the charging station and the coupling unit, the charging station may have a guide device which, for example, is like a funnel or is in the form of guide plates, by means of which the coupling element which is fixed to the vehicle is guided to the charging element of the charging station.

In order to prevent damage to the charging system when the charging element and the coupling element are being coupled, at least one of these two elements may be mounted elastically. When the charging element and the coupling element meet one another, the system is therefore flexible.

When the charging system according to the invention is a conductive charging system, the coupling element of the coupling unit which is fixed to the vehicle and the charging element of the stationary charging unit expediently each have two contact elements for coupling the coupling unit to the charging station.

In the case of a conductive charging system, the charging element of the charging station may represent a rail which has two contact springs, which can each be electrically connected to one electrode of the coupling element of the coupling unit which is fixed to the vehicle.

When the charging system according to the invention is an inductive charging system, the charging station forms the primary side, and the coupling unit which is fixed to the vehicle forms the secondary side, of the inductive charging system.

Particularly in the case of an inductively operating charging system, it is feasible for the charging element of the charging station to be arranged on the inner face of a garage door and, for example, to be like a rail. When the garage door is in the closed position, the charging element is coupled to the coupling element of the coupling unit, which is fixed to the vehicle, of the motor vehicle which is parked in the garage. Therefore, when the garage door is pivoted, the charging element is made to engage with the coupling element. For example, a rear bumper of the motor vehicle may thus represent the secondary side of an inductive charging system which, when the garage door is closed, is made to engage with a primary side, in the form of a charging rail, of the charging system, which represents the charging element of the charging station.

The charging system according to the invention furthermore expediently has an activation switch which preferably automatically activates the charging system when the charging element has assumed a charging position with respect to the coupling element. In the case of a garage door, the activation switch may be integrated in the garage door and may identify that the garage door is in the closed position, in which the charging system is activated.

The subject matter of the invention also includes a system for charging a battery in a motor vehicle, having a stationary charging station and a coupling unit which is fixed to the vehicle, wherein the coupling unit which is fixed to the vehicle has a coupling element which is arranged on the vehicle floor or on the vehicle roof, and whose relative position with respect to a charging element of the charging station is adjustable.

In the case of the system which is provided in the roof area or floor area of the vehicle, the coupling element and/or the charging element may be provided with lifting and lowering kinematics.

By way of example in the case of an inductive charging system, the vehicle has a base plate which forms the secondary side when a primary side has been incorporated in the ground under a vehicle parking space, and can be lowered in order to increase the efficiency during charging, thus minimizing the distance between the base plate and the secondary side.

When the secondary side of an inductive charging system is provided on the vehicle roof, it is advantageous for the charging element, which forms the primary side, of the charging station to be lowered to a minimum distance from the coupling element which forms the secondary side. The charging element can be provided with a distance sensor in order to avoid accidentally moving onto the vehicle roof, and damaging it. By way of example, charging stations such as these can be integrated in car parks, such as parking garages, duplex garages and the like.

Further advantages and advantageous refinements of the subject matter of the invention can be found in the description, the drawing and the patent claims.

Exemplary embodiments of a charging system according to the invention will be explained in more detail in the following description, and are illustrated in a schematically simplified form in the drawing, in which:

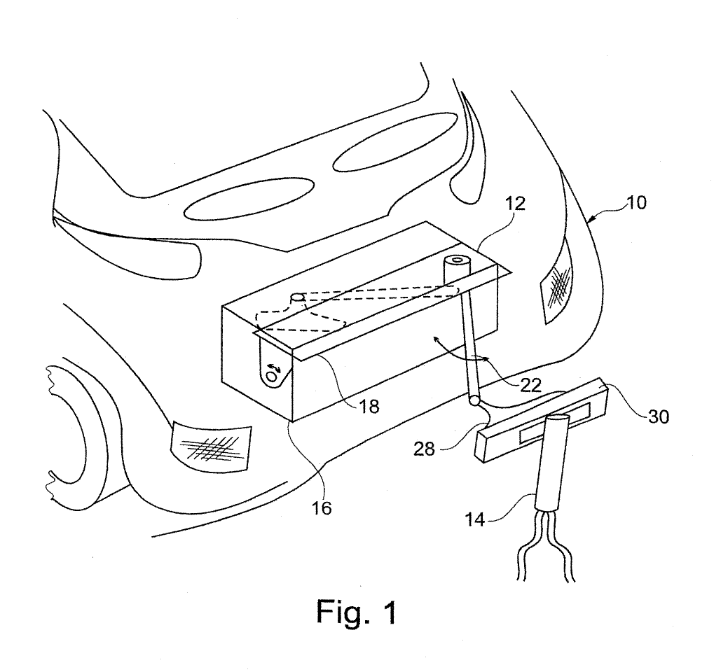

FIG. 1 shows a perspective front view of an electric vehicle coupled to a charging station;

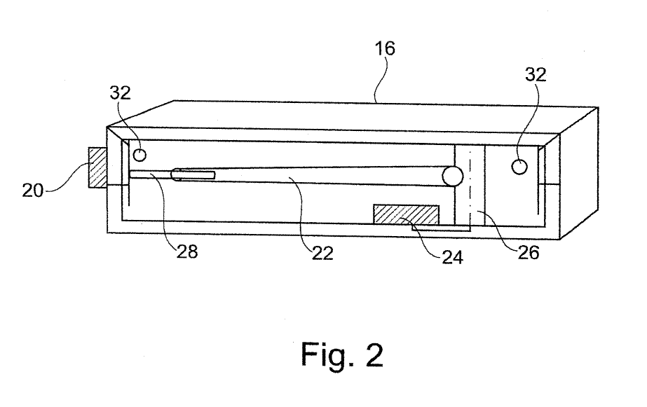

FIG. 2 shows a housing for supporting a charging arm on the motor vehicle;

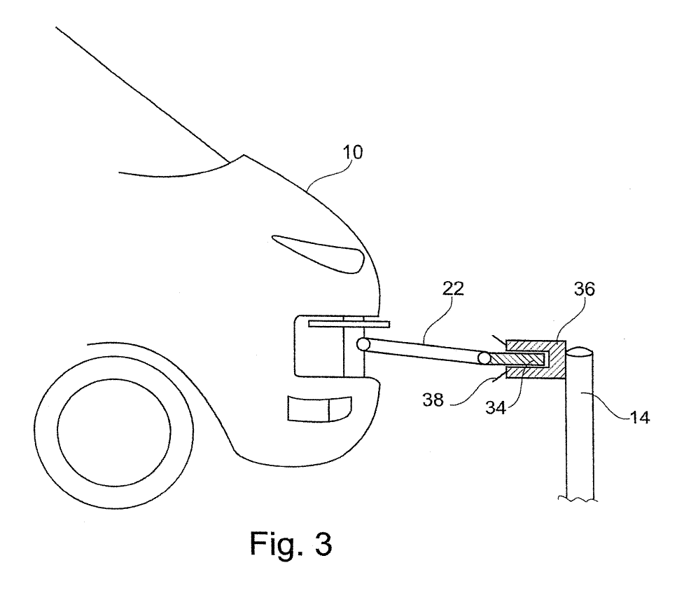

FIG. 3 shows a side view of a vehicle front with a charging arm which is coupled to an inductive coupling of a charging station;

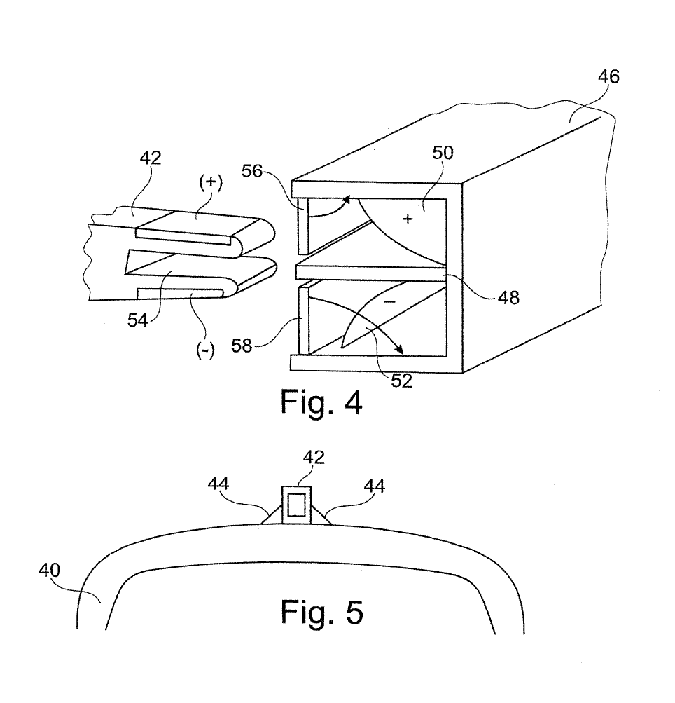

FIG. 4 shows an alternative embodiment of a charging system, which is in the form of a conductive charging system;

FIG. 5 shows a plan view of a vehicle front with a charging arm of the charging system illustrated in FIG. 4;

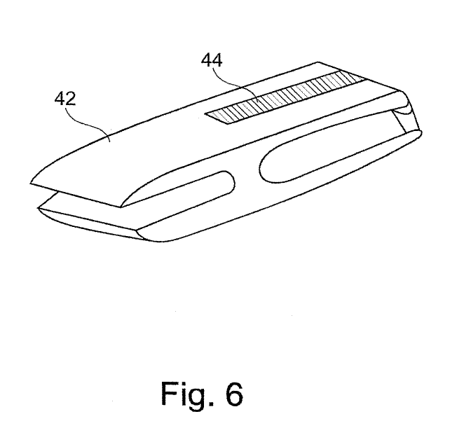

FIG. 6 shows the charging arm of the charging system illustrated in FIG. 4, on its own;

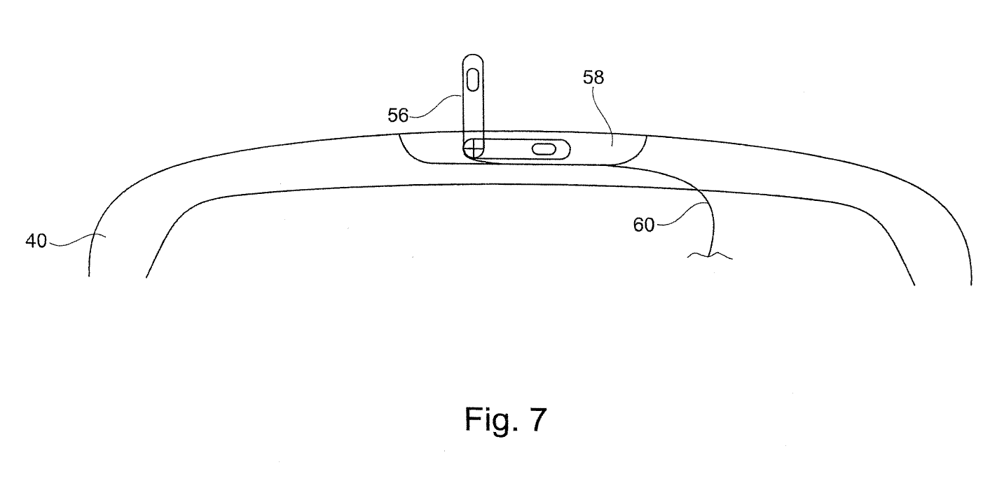

FIG. 7 shows a charging arm which can pivot and is integrated in a bumper of a motor vehicle; and

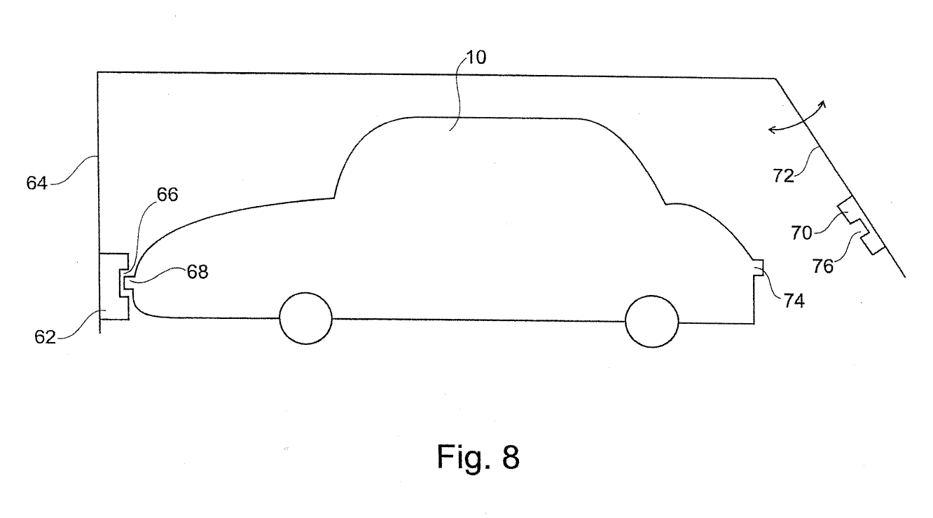

FIG. 8 shows various inductively operating charging systems, integrated in a garage.

FIG. 1 shows a motor vehicle 10 which is in the form of an electric vehicle and has a coupling unit 12 at its front in order to charge its battery, which coupling unit 12 can be coupled to a stationary, external charging station 14. The charging station is, for example, adjacent to a public parking space.

The coupling unit 12 has a housing 16 which is integrated in the vehicle structure and is provided on its end face with a cover element 18 which is mounted such that it can pivot. The cover element 18 which is mounted such that it can pivot represents a license plate of the motor vehicle 10, and is provided with a drive 20, which is illustrated in more detail in FIG. 2 and which can be operated when required, that is to say in order to charge the battery in the motor vehicle 10.

Furthermore, a charging arm 22 is mounted such that it can pivot in the housing 16, via a bolt 26 which is driven by means of an electric motor 24. The bolt 26 is clamped in between the upper and the lower boundary wall of the housing 16. On its free end face, the charging arm 22 is fitted with electrodes 28 for coupling to electrodes, which are provided on a charging element 30 of the charging station 14.

In order to allow the electrodes 28 to be engaged accurately in position with the electrodes on the charging element 30, sensors 32 are provided in the housing 16 which, on the one hand, can determine the distance between the motor vehicle 10 and the charging station 14 and, on the other hand, can be used as a positioning aid for moving the charging arm 22 to the charging element 30 of the charging station 14.

The exemplary embodiment illustrated in FIG. 3 differs from that shown in FIGS. 1 and 2 in that it represents a charging system which is not in the form of a conductively operating charging system, but is in the form of an inductively operating charging system. In particular, in this case, the charging arm 22 is provided on its free end face with a first inductive coupling 34, which represents the secondary side of the charging system and is also provided with an electrical coil. In the charging position, the inductive coupling 34 on the charging arm 22 engages in a second inductive coupling 36, which represents the primary side of the charging system and is likewise provided with an electrical coil. The second inductive coupling 36 of the charging station 14 is in the form of a rail and has guide plates 38, which are in the form of catchment funnels on its open face and, when the charging arm 22 is pivoting, guide the first inductive coupling 34 into the second inductive coupling 36, which is like a rail. Apart from this, the design of the charging system illustrated in FIG. 3 corresponds to that of the charging system shown in FIGS. 1 and 2.

A further embodiment of a charging system according to the invention is illustrated in FIGS. 4 to 6. This charging system is integrated in a front bumper 40 of a motor vehicle, which is otherwise not illustrated in any more detail, and has a charging arm 42 which is associated with a coupling unit which is fixed to the vehicle, and which charging arm 42 can be extended out of a receptacle in the bumper 40 in order to charge the battery in the motor vehicle, which is in the form of an electric vehicle. When the charging arm 42 is being extended, it is moved onto two flaps 44, which are mounted in a sprung manner, such that they are pivoted to the open position, and the charging arm 42 projects beyond the bumper 40 at the front.

In the charging position, the charging arm 42, which has a toothed section 44 in which a gearwheel which is driven by means of an electric motor engages for drive purposes, is coupled to a charging rail 46, which is arranged stationary adjacent to a parking space for the relevant motor vehicle.

The charging rail 46 represents a U-shaped profile in which a separating wall 48 is arranged, which mechanically and electrically isolates two contact springs 50 and 52 from one another. The corresponding poles of the charging arm 42 rest on the contact springs 50 and 52, which are respectively associated with a positive pole and a negative pole of the charging rail 46, when in the charging position.

When the charging arm 42 on the motor vehicle is being coupled to the charging rail 46, the separating wall 48 of the charging rail 46 enters a slot 54, which separates the two poles, in the charging arm 42. Furthermore, spring-loaded protection flaps 56 and 58 on the charging rail 46 are pivoted to the open position by the insertion of the charging arm 42 into the charging rail 46.

It is also feasible for an inductively operating charging system to be designed as illustrated in FIGS. 4 to 6. In this case, the charging rail 46 and the charging arm 42 would each be provided with an electrical coil, respectively associated with the primary side and the secondary side of the charging system.

FIG. 7 shows an alternative embodiment of a conductively operating charging system, in which a charging arm 56 is likewise arranged in a bumper 40 of a motor vehicle. In this embodiment, the charging arm 56 is mounted such that it can pivot, and can be pivoted out of a recess 58 in the bumper 40 in order to pivot it from a rest position to a charging position, such that it projects forward beyond the bumper 40 in the direction of travel.

The embodiment illustrated in FIG. 7 requires only a small amount of space. Furthermore, it is not essential to provide a protective flap or the like for the recess 58. The charging arm is driven by means of a cable run 60, which can be operated manually or else by means of an actuating drive, which is arranged in a suitable manner in the motor vehicle.

FIG. 8 shows further charging systems according to the invention. One of these charging systems has a charging rail 62 of a charging station, which is attached to a garage wall 64 and has a recess 66. The recess 66 is arranged at the same height as the bumper 68 of a motor vehicle 10 and engages in the recess 66 in the charging position. The bumper 68 represents a coupling unit, which is fixed to the vehicle, of the charging system. The charging system is in the form of an inductively operating charging system, with the charging rail 62 representing the primary side, and the bumper 68 the secondary side, of the charging system. The charging rail 62 can be mounted elastically. The bumper 68 can also be mounted elastically on the vehicle structure.

Furthermore, FIG. 8 illustrates a charging system which has a charging rail 70 which is attached to the inner face of a garage door 72 which can pivot, and is associated with a charging station. When the garage door 72 is in the closed position, a rear bumper 74 on the motor vehicle 10 engages in a recess 76 in the charging rail 70. This charging system is also in the form of an inductively operating charging system, with the charging rail 70 being associated with the primary side, and the bumper 74 with the secondary side, of the charging system. When the garage door 72 is closed and the bumper 74 engages in the recess 76 in the charging rail 70, an activation switch, which is not illustrated in any more detail, is operated and initiates the charging process, that is to say activates the charging system.

Alternatively, the charging rail which is provided on the garage door or on the wall can also be designed such that, when in the charging position, it engages in a recess on the relevant bumper of the vehicle.

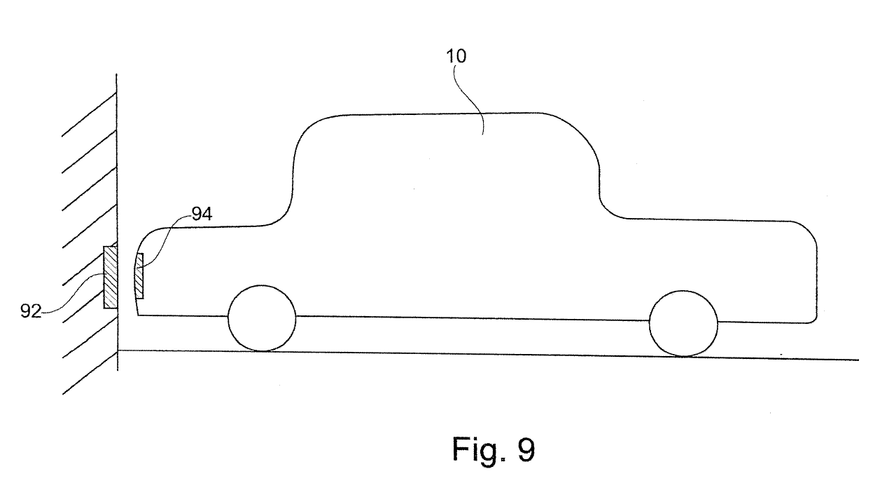

A further embodiment according to the invention, which is illustrated in FIG. 9 and is likewise in the form of an inductive charging system, has a charging plate 92 as the primary side, which is mounted on a garage wall and forms the charging element of the charging station, and has a coupling plate 94 on the vehicle side, which forms the coupling element of the coupling unit that represents the secondary side of the charging system.

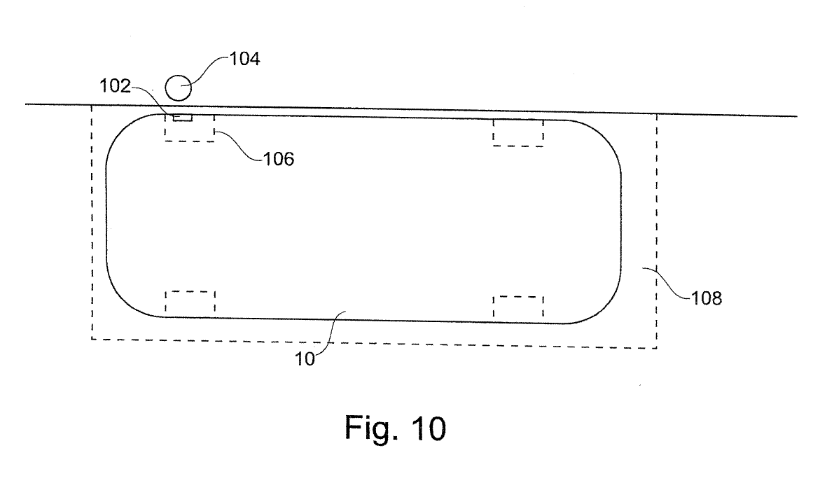

In a further embodiment, which is illustrated in FIG. 10, a coupling element 102 which forms the secondary side of an inductive charging system can be arranged on the vehicle side, for example in the area of a wheel box 106. The charging element which forms the primary side of the charging station is then, for example a pillar 104, which is arranged adjacent to the edge of a public or private parking space 108, and the relevant vehicle 10 is moved to a minimal distance away from this, in order to charge the battery. This can be done by means of an automated positioning system, which automatically guides the vehicle into the optimum parking position, to be precise by operating the steering and drive system.

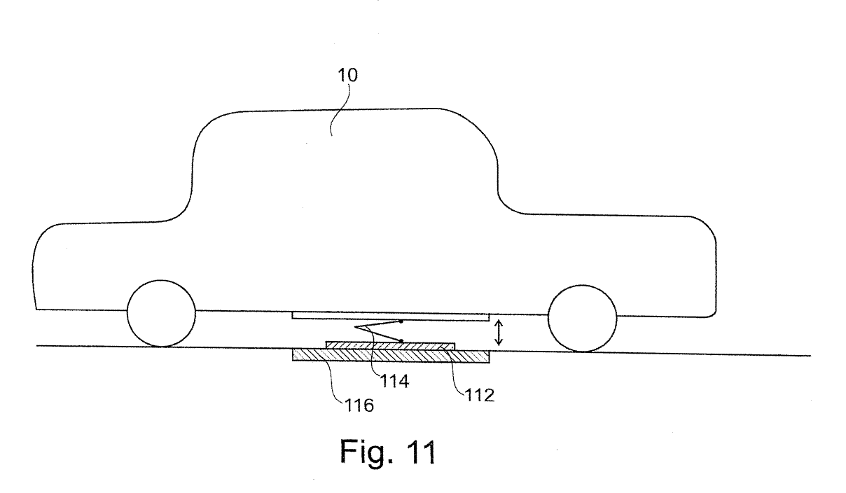

In FIG. 11, in a further embodiment of a charging system according to the invention, a coupling plate 112 which forms the secondary side of an inductive charging system is arranged on the floor of a vehicle. The coupling plate 112 is provided with lifting and lowering kinematics 114, which are lowered onto a base plate 116 in order to charge the battery in the vehicle 10, which is in the form of an electrical vehicle, with the base plate 116 being integrated in a parking space for the vehicle. The lifting and lowering kinematics can be operated from inside the vehicle.

### LIST OF REFERENCE SYMBOLS

10 Motor vehicle
12 Coupling unit
14 Charging station
16 Housing
18 Cover element
20 Drive
22 Charging arm
24 Electric motor
26 Bolt
28 Electrode
30 Charging element
32 Sensors
34 Inductive coupling
36 Inductive coupling
38 Guide plates
40 Bumper
42 Charging arm
44 Toothed section
46 Charging rail
48 Separating wall
50 Contact spring
52 Contact spring
54 Slot
56 Charging arm
58 Recess
60 Cable run
62 Charging rail
64 Garage wall
66 Recess
68 Bumper
70 Charging rail
72 Garage door
74 Bumper
76 Recess
92 Charging plate
94 Coupling plate
102 Coupling element
104 Pillar
106 Wheel box
108 Parking space
112 Coupling plate
114 Lifting and lowering kinematics
116 Base plate

1. A system for charging a battery in a motor vehicle, comprising a stationary charging station and a coupling unit that is fixed to the vehicle, wherein the coupling unit that is fixed to the vehicle has a coupling element that is arranged at the vehicle front, at the vehicle rear, or on one of the vehicle sides, and which is electrically coupled, at least in a charging position, to a charging element of the charging station, with the coupling element projecting with respect to a fixed vehicle outer skin section and engaging in the charging element of the charging station, or engaging in the coupling element when the charging element of the charging station is in a charging position, or the coupling element being integrated flush, without any contours or concealed in the vehicle front, at the vehicle rear or on one of the vehicle sides, and being inductively coupled to the charging element of the charging station in a charging position.

2. The charging system as claimed in claim 1, wherein the coupling element is arranged rigidly with respect to the vehicle structure.

3. The charging system as claimed in claim 2, wherein the coupling element is at least part of a bumper of the motor vehicle which, in the charging position, engages in a charging rail, which forms the charging element, of the charging station.

4. The charging system as claimed in claim 1, wherein the coupling element is a charging arm.

5. The charging system as claimed in claim 4, wherein the charging arm can be moved linearly.

6. The charging system as claimed in claim 4, wherein the charging arm can pivot.

7. The charging system as claimed in claim 4, comprising a cable run for driving the charging arm.

8. The charging system as claimed in claim 4, wherein the charging arm is mounted in a housing that is fixed to the vehicle.

9. The charging system as claimed in claim 8, wherein the housing has a cover element that can pivot.

10. The charging system as claimed in claim 9, comprising a drive for the cover element.

11. The charging system as claimed in claim 10, wherein the cover element is pre-stressed in the closing direction by a spring device.

12. The charging system as claimed in claim 9, wherein the cover element that can pivot is a license plate of the motor vehicle.

13. The charging system as claimed in claim 1, wherein the coupling unit that is fixed to the vehicle has at least one distance sensor for measurement of the distance between the coupling element and the charging element.

14. The charging system as claimed in claim 1, comprising an automatic positioning device which, when the vehicle is parked, guides the coupling element to the charging element of the charging station or guides the charging element of the charging station to the coupling element on the coupling unit that is fixed to the vehicle.

15. The charging system as claimed in claim 1, comprising an automatic positioning device that guides the vehicle to a charging position and interacts with a steering unit and/or a drive unit in the vehicle.

16. The charging system as claimed in claim 1, comprising a visual and/or audible signaling unit, which signals that the charging position has been reached.

17. The charging system as claimed in one claim 1, wherein the charging station has a guide device for coupling the coupling element of the coupling unit, that is fixed to the vehicle, to the charging element of the charging station.

18. The charging system as claimed in claim 1, wherein the charging system is a conductive charging system, and the coupling element of the coupling unit that is fixed to the vehicle and the charging element of the stationary charging station each have two contact elements for coupling the coupling unit to the charging station.

19. The charging system as claimed in claim 18, wherein the charging element has a rail with two contact springs for respective coupling to one electrode of the coupling element of the coupling unit that is fixed to the vehicle.

20. The charging system as claimed in claim 1, wherein the charging system is an inductive charging system, and the charging station forms the primary side, and the coupling unit that is fixed to the vehicle forms the secondary side, of the inductive charging system.

21. The charging system as claimed in claim 1, wherein the charging element of the charging station is arranged on an inner face of a garage door, in whose closed position the charging element is coupled to the coupling element of the coupling unit that is fixed to the vehicle.

22. The charging system as claimed in claim 1, comprising an activation switch, which preferably activates the charging system when the charging element has assumed a charging position with respect to the coupling element.

23. The charging system as claimed in claim 1, wherein the charging station has kinematics, by which the vertical position of the charging element can be matched to the vertical position of the coupling element.

24. A system for charging a battery in a motor vehicle, having a stationary charging station and a coupling unit that is fixed to the vehicle, wherein the coupling unit that is fixed to the vehicle has a coupling element that is arranged on the vehicle floor or on the vehicle roof, and whose relative position with respect to a charging element of the charging station is adjustable.

25. The system as claimed in claim 24, wherein the coupling element and/or the charging element are/is provided with lifting and lowering kinematics.

26. The charging system as claimed in claim 4, wherein the charging arm can be extended with respect to the vehicle structure by a drive.

27. The charging system as claimed in claim 5, wherein the charging arm has a toothed-rod section that engages a drive wheel.
